(19) United States
(12) Patent Application Publication
(10) Pub. No.: US 2023/0392704 A1
(43) Pub. Date: Dec. 7, 2023

(54) GATE VALVE CAVITY REDUCER

(71) Applicant: OIL STATES ENERGY SERVICES, L.L.C., Houston, TX (US)

(72) Inventors: Jimmy Livingston, Manvel, TX (US); Haifang Zhao, Katy, TX (US); Bob McGuire, Meridian, OK (US)

(73) Assignee: OIL STATES ENERGY SERVICES, L.L.C., Houston, TX (US)

(21) Appl. No.: 17/829,927

(22) Filed: Jun. 1, 2022

(51) Int. Cl. F16K 27/04

(52) U.S. Cl. CPC F16K 27/044; F16K 3/36

(57) ABSTRACT

A gate valve cavity reducer comprising a cavity reducer with an outer surface, a channel having an inner surface, and a plurality of bores extending through the cavity reducer body. Each of the plurality of bores extend radially from the inner surface of the cavity reducer to the outer surface of the cavity reducer. The cavity reducer is configured to be removed or inserted into a gate valve.

### TECHNICAL FIELD

The present disclosure relates generally to gate valves, and more particularly, to the operation and maintenance thereof.

### BACKGROUND

A gate valve is generally used to regulate fluid flow through a central bore within the body of the valve. The gate valve is a movable component that will either allow fluid flow or obstruct fluid flow. When the gate valve is fully open, fluid is allowed to travel through the bore. When the gate valve is closed, the fluid flow is obstructed. To ensure that flow is obstructed, gate valves generally include a seat which contacts the gate and forms a seal to prevent fluid from leaking out of the central bore when the valve is in the closed position.

As the gate valve moves between the open position and the closed position, this movement results in wear on the valve, particularly at the point where the seat contacts the gate. To minimize this wear and aid in ease of operation, the area around the gate, also sometimes referred to as the valve cavity, is often filled with a lubricant such as grease.

Due to the configuration of gate valves, they generally include a cavity that is significantly larger than other types of valves, such as ball valves or plug valves. As a result, there are significant costs associated with filling the entire cavity of a gate valve with grease. In addition to the initial cost of the grease required to fill the cavity, grease becomes contaminated by various substances while the valve is in use. Disposing of contaminated grease can be quite expensive, nearly as much as the cost of new grease. Contaminated grease also often includes hazardous substances that require special handling and pose potential risks to the environment.

Certain prior art devices have proposed solutions to address the volume of grease needed. However, these solutions have either narrowly reduced the amount of grease needed or created additional issues such as making the gate valve less accessible for service.

Therefore, what is needed is an apparatus, system or method that addresses one or more of the foregoing issues, among one or more other issues.

### SUMMARY

A gate valve cavity reducer may comprise a body with an outer surface, a channel having an inner surface, and a plurality of bores extending through the body. Each of the plurality of bores extend radially from the inner surface of the cavity reducer to the outer surface of the cavity reducer. The cavity reducer is configured to be removed or inserted into a gate valve.

A gate valve comprising a valve body, a valve element disposed within the valve body volume so that the valve element is movable, and a cavity reducer disposed within the valve body volume. The cavity reducer defines a channel to permit movement of the valve element. The cavity reducer includes a plurality of bores extending radially from the channel of the cavity reducer body to an outer surface of the cavity reducer body. In some embodiments, the cavity reducer body includes an upper cavity reducer and a lower cavity reducer.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a cross-sectional side view of a gate valve cavity reducer, in accordance with embodiments of the present disclosure;

FIG. 2 is a cross-sectional side view of the upper half of the gate valve cavity reducer, in accordance with embodiments of the present disclosure;

FIG. 3 is a cross-sectional side view of the top of the gate valve cavity reducer, in accordance with embodiments of the present disclosure;

FIG. 4 is a cross-sectional side view of the lower half of the gate valve cavity reducer, in accordance with embodiments of the present disclosure;

FIG. 5 is a cross-sectional perspective view of the lower half of the gate valve cavity reducer, in accordance with embodiments of the present disclosure; and

FIG. 6 is a top view of the of the lower half of the gate valve cavity reducer, in accordance with embodiments of the present disclosure.

### DETAILED DESCRIPTION

The present disclosure relates generally to gate valves, and more particularly, to the operation and maintenance thereof. As described herein, embodiments of the gate valve described herein address certain issues described above with respect to traditional gate valve configurations.

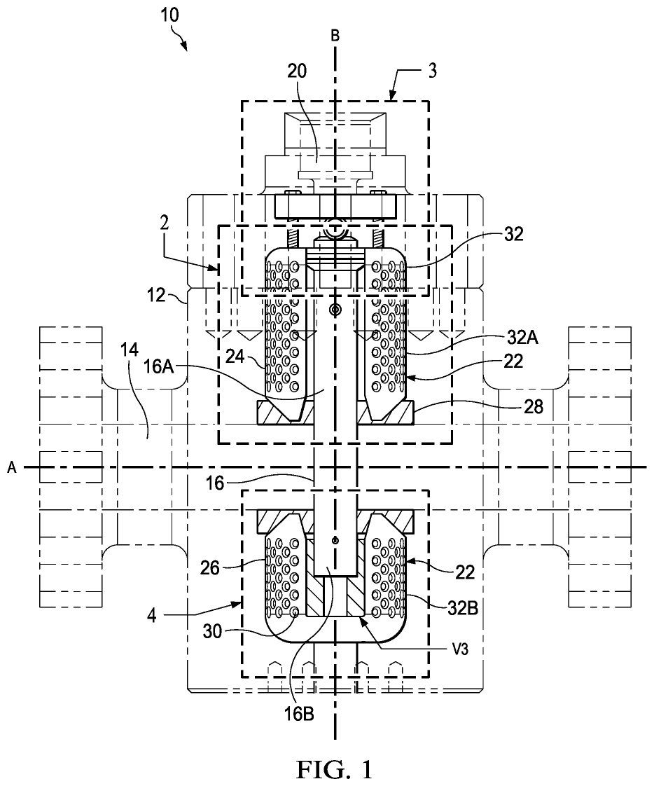

FIG. 1 provides a cross-sectional side view of a gate valve 10 with a cavity reducer 22, in accordance with embodiments of the present disclosure. The gate valve 10 controls the flow of fluid and is operated to selectively block the flow of fluid.

The gate valve 10 includes a valve body 12 which intersects a flow passage 14. The flow passage 14 includes central longitudinal axis A and comprises a throughbore, such that fluid is allowed to flow entirely through valve body 12, as long as the valve is not in the closed position, as discussed further below. A person of skill in the art would understand that fluid could flow through the flow passage 14 in either direction.

The valve body 12 includes a chamber 32, which includes central vertical axis B and comprises an upper portion 32A, which is generally adjacent to actuator 20 that is used to open and close the valve, and lower portion 32B. Cavity 32 intersects flow passage 14 is oriented such that central vertical axis B is substantially perpendicular to central longitudinal axis A of flow passage 14.

Gate 16 is disposed within cavity 32, and also comprises upper portion 16A disposed within upper portion 32A of the chamber and lower portion 16B disposed within lower potion 32B of the chamber. A person of ordinary skill would understand that the gate 16 could be replaced by a different flow barrier, such as a plug.

The gate 16 intersects the flow passage 14 at a valve seat 28. Valve seat 28 forms a seal with the surface of gate 16 to prevent fluid in flow passage 14 from passing into chamber 32. Due to that engagement, opening and closing of the valve results in friction between gate 16 and valve seat 28. Such friction can result in wear on valve seat 28, as well as an increase in the amount of force required to open and close the valve. To reduce such friction, a lubricant such as grease is often used at the interface between valve seat 28 and gate 16. Grease is often disposed at the interface between valve seat 28 and gate 16 by simply filling cavity 32 with grease. This approach can be expensive and inefficient, given the cost of grease. In addition, as noted above, grease within cavity 32 will become contaminated over time, which requires expensive and environmentally hazardous removal and disposal.

As shown in FIG. 1, a cavity reducer 22 can be disposed within cavity 32 of the gate valve 10. The cavity reducer 22 can reduce the amount of grease needed by displacing the volume within cavity 32. In some embodiments, the cavity reducer 22 is custom designed to fit within the existing cavity 32 of a gate valve 10. In some embodiments, the gate valve 10 already includes a cavity reducer 22. In the illustrated embodiment, the cavity reducer 22 includes an upper cavity reducer 24 disposed within upper portion 32A of the chamber and a lower cavity reducer 26 disposed within lower portion 32B.

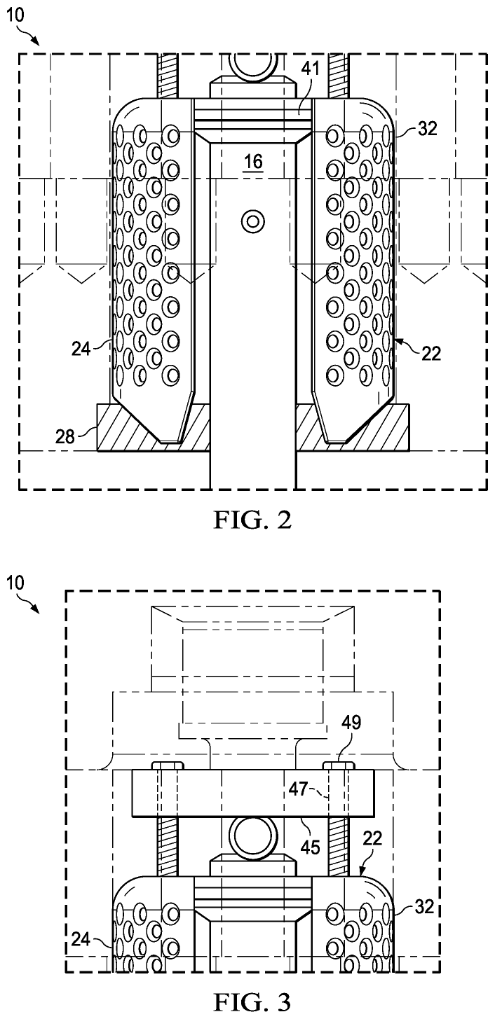

FIG. 2 is a cross-sectional side view of the upper half of the cavity reducer 24, in accordance with embodiments of the present disclosure. In some embodiments, the upper cavity reducer 24 is inserted into cavity 32 above the seat 28. The upper cavity reducer 24 includes a central channel formed so that gate 16 can move along the channel. Embodiment can also include spacer 41 to assist in channel gap opening. In this embodiment, the upper cavity reducer 24 also serves as a guide for gate 16 as it moves between the open position and the closed position.

FIG. 3 is a cross-sectional side view of the upper cavity reducer 24, in accordance with embodiments of the present disclosure. An insert removal tool 45 may be used to remove and reinsert the upper cavity reducer 24 into cavity 32. The insert removal tool is fastened to the cavity reducer 22 via a bolt 49 that is disposed within a bore 47 in the insert removal tool 45.

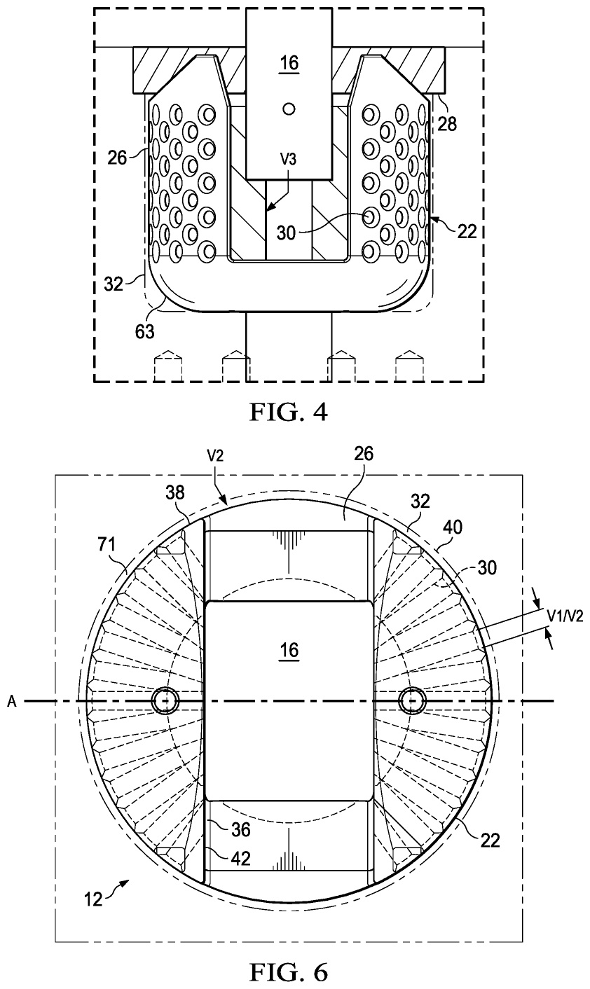

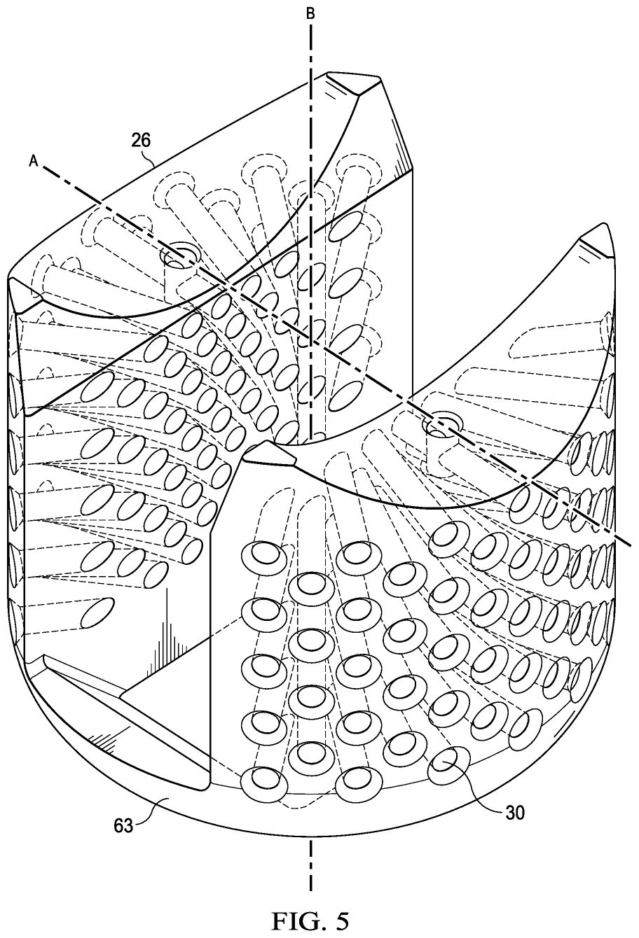

FIG. 4 is a cross-sectional side view of the lower cavity reducer 26, in accordance with embodiments of the present disclosure. FIG. 5 is a cross-sectional view of the lower cavity reducer 26, in accordance with embodiments of the present disclosure. With reference to FIGS. 5 and 6, in some embodiments, the lower cavity reducer 26 is inserted into cavity 32 below the seat 28. The lower cavity reducer 26 includes a central channel formed by a support 63 so that gate 16 can move vertically to engage with the seat 28. In this embodiment, the lower cavity reducer 26 also serves as a guide for gate 16 as it moves between the open position and the closed position.

In some embodiments, the cavity reducer 22 can include one or more passages to allow for movement of grease or other lubricant within cavity 32 during operation of the gate valve. In some embodiments, the cavity reducer 22 includes a plurality of bores 30 such that a lubricant in cavity 32 can pass through cavity reducer 22 and lubricate the interface between gate 16 and seat 28. The grease within the cavity 32 does not prohibit the operation of the gate 16 as it moves between the open and closed position.

FIG. 6 is a top view of the lower cavity reducer 26, in accordance with embodiments of the present disclosure. In some embodiments, cavity reducer 22 is placed within the cavity 32 of the valve body 12, which conventionally is filled with grease. By inserting the cavity reducer 22, grease in the volume of the cavity 32 is displaced into an annulus 71 formed or defined between an outer surface 38 of the cavity reducer 22 and an inner surface or wall 40 of the cavity 32.

In some embodiments, the plurality of bores 30 are in a radial arrangement and are oriented substantially parallel to central longitudinal axis A of flow passage 14. In the illustrated embodiment, each bore 30 extends radially outward from central vertical axis B of cavity 32 towards the annulus between cavity reducer 22 and wall 40 of cavity 32. As illustrated, a portion of the plurality of bores extend perpendicularly outward from an inner surface 42 of a central channel 36. In some embodiments, a portion of the plurality of bores 30 extend at an acute angle relative to an inner surface 42 of the central channel 36. In some embodiments, each bore 30 has a circular cross-sectional profile extending radially or a tubular shape. In the illustrated embodiment, the plurality of bores are axially spaced equidistant from other bores. A person of skill in the art would understand that the plurality of bores could be arranged in a different configuration, such as a staggered arrangement.

A person of skill in the art would understand that the amount of grease disposed in the volume of the plurality of the bores can be greater than the amount of grease disposed between the cavity reducer 22 and a wall of the axial channel 40.

The number and size of bores 30 may be selected based on the volume of grease within cavity 32 after the insertion of cavity reducer 22 and gate 16. In particular, there will be a portion of remaining volume (V3) within cavity 32 and an additional volume (V2) of the annulus 71 between cavity reducer 22 and wall 40 of cavity 32. This total volume (V2+V3) within cavity 32 will be filled with grease. The plurality of bores 30 will collectively have a volume (V1), which provides a pathway for the grease, ensuring that a certain portion of the total volume of grease V2+V3 remains deployable. For example, it may be considered desirable for at least ⅓ of the total volume of grease to remain deployable, such that V1≥⅓(V2+V3).

The upper cavity reducer 24 and the lower cavity reducer 26 may be manufactured using a molding process. In some embodiments, a NYCAST® NYLOIL Type 6 Oil Filled Nylon material is used. A person of skill in the art would understand that any non-metallic, castable, and machinable material could be used. The material for the cavity reducer 22 may be poured into a cast to form the diameter and length of the cavity reducer 22. The upper cavity reducer 24 may be two separate parts made from the same cast blank. The lower cavity reducer 26 may be formed in a single cast. The molds may then be placed in a multi-axis machine which will turn the external profiles. Bores may then be drilled into the mold of the cavity reducer in the arrangement as determined based on the volume discussion above. In some embodiments, the cavity reducer components are also milled.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A valve comprising:
a valve body comprising:
a flow passage comprising a central longitudinal axis; and
a cavity comprising:
an inner curved surface with a first radius of curvature; and
a central vertical axis substantially perpendicular to the central longitudinal axis;
a flow barrier disposed within the cavity;
a first cavity reducer body comprising an outer curved surface with a second radius of curvature substantially the same as the first radius of curvature, an inner surface, and a plurality of bores extending through the first cavity reducer body radially outward from the central vertical axis;
wherein the first cavity reducer body is disposed within the cavity and configured such that the flow barrier moves within the inner surface of the first cavity reducer body and an annulus is formed between the outer surface of the first cavity reducer body and the inner surface of the cavity.

2. The valve of claim 1, wherein the cavity comprises an upper portion on a first side of the flow passage and a lower portion on the opposite side of the flow passage.

3. The valve of claim 1, wherein the first cavity reducer body is disposed within the upper portion of the cavity.

4. The valve of claim 3, further comprising a second cavity reducer body disposed within the lower portion of the cavity.

5. The valve of claim 1, wherein each bore has a substantially circular cross-sectional profile.

6. The valve of claim 5, wherein each bore has approximately the same diameter.

7. The valve of claim 1, wherein the plurality of bores are positioned equidistantly around the cavity reducer body.

8. The valve of claim 1, wherein the plurality of bores extend perpendicular to the central vertical axis of the cavity.

9. The valve of claim 1, wherein the plurality of bores extend parallel to the central longitudinal axis of the flow passage.

10. The valve of claim 1, wherein the annulus comprises a first volume, the plurality of bores collectively comprise a second volume, and the second volume is greater or equal to one-third of the first volume.

11. A method of reducing an internal volume of a valve comprising:
inserting a first cavity reducer body into a valve cavity comprising a central vertical axis and a curved inner surface with a first radius of curvature, wherein the first cavity reducer body comprises a curved outer surface with a second radius of curvature substantially the same as the first radius of curvature and a plurality of bores extending through the first cavity reducer body radially outward from the central vertical axis; and
directing grease within the cavity through the plurality of bores to an interface between a flow barrier and a valve seat.

12. The method of claim 11, wherein the cavity comprises an upper portion and a lower portion and the first cavity reducer body is inserted into the upper portion of the cavity.

13. The method of claim 11, further comprising the step of inserting a second cavity reducer body into the lower portion of the cavity.

14. The method of claim 11, wherein each bore has a substantially circular cross-sectional profile.

15. The method of claim 11, wherein each bore has approximately the same diameter.

16. The method of claim 11, wherein the plurality of bores are positioned equidistantly around the cavity reducer body.
